(19) United States
(12) Patent Application Publication
(10) Pub. No.: US 2024/0317331 A1
(43) Pub. Date: Sep. 26, 2024

(54) TRACTOR

(71) Applicant: SIMA INVESTMENT AG, Horw (CH)

(72) Inventor: Marco SIEBER, Horw (CH)

(73) Assignee: SIMA INVESTMENT AG, Horw (CH)

(21) Appl. No.: 18/571,799

(22) PCT Filed: Jun. 30, 2022
(86) PCT No.: PCT/EP2022/068084

§ 371 Date: Dec. 19, 2023

(30) Foreign Application Priority Data
Jul. 23, 2021 (DE) 10 2021 119 193.9

(51) Int. Cl. B62D 49/06; B60K 1/00; B60K 17/356

(52) U.S. Cl. CPC B62D 49/06; B60K 1/00; B60K 17/356

(57) ABSTRACT

A tractor for agricultural use includes a chassis, which connects a front tractor part and a rear tractor part to one another via a connecting element, a driver's seat in the region of the rear tractor part, a drive and at least four wheels. The connecting element of the chassis, which connects the rear and the front tractor parts to one another, is disposed at least 60 cm above the driver's seat and extends substantially horizontally up to the front tractor part. The driver can thus look to the right, and also at an implement disposed behind the front tractor part, below the connecting element. This enables precise maneuvering when tilling the soil for rows of plants.

### CROSS REFERENCE TO RELATED APPLICATIONS

This application is the National Stage of PCT/EP2022/068084 filed on Jun. 30, 2022, which claims priority under 35 U.S.C. § 119 of German Application No. 10 2021 119 193.9 filed on Jul. 23, 2021, the disclosure of which is incorporated by reference. The international application under PCT article 21(2) was not published in English.

### BACKGROUND OF THE INVENTION

### 1. Field of the Invention

The invention relates to a tractor for agricultural use having a chassis, which connects a front tractor part and a rear tractor part to one another via a connecting element, a driver's seat in the region of the rear tractor part, a drive and at least four wheels, wherein the connecting element of the chassis, which connects the rear tractor part and the front tractor part to one another, is arranged at least 60 cm above the driver's seat and extends essentially horizontally to the front tractor part.

### 2. Description of the Related Art

Nowadays, tractors for agriculture are predominantly powered by diesel engines. In arable farming, heavy tractors weighing over 5 tonnes are predominantly used. Their task is to pull large and heavy agricultural machinery. Smaller tractors weighing between 1.5 or 3 tonnes are used for cultivating low plants arranged in rows, such as in vegetable growing or in tree nurseries. As these plants are planted in rows with spaces between them, the lighter weight of the tractor reduces unwanted soil compaction between the rows of small plants.

In order to prevent weeds or grass from forming between the rows of plants, pesticides can be sprayed. while hoeing equipment or hoeing brushes (see https://www.baertschi.com/de/fobro-schar-und-sternhackgerate/) can also be used to mechanically pull out the weeds between the rows or damage their roots so that they can no longer grow and thus cannot compete with the actual crop in terms of food uptake from the soil. This mechanical soil cultivation is mainly used for the organic cultivation of vegetables.

A special vehicle that fulfils this task is the Fobro-Mobil (https://fobro-mobil.ch/de/fobromobil-d49/). This vehicle is powered by a diesel or petrol engine. The Fobro-Mobil has 3 holders for implements, such as chippers or hoeing brushes. These implements can be mounted at the rear of the tractor, at the front of the tractor and in the center of the tractor, directly in front of the driver's seat. For this purpose, the front and rear axles were connected with 2 tubes above the driver's head. This allows the driver to see the hoeing device mounted in the center support directly in front of them and to steer it precisely between the rows of plants without damaging the crop. Normal tractors do not have a center attachment for implements-they have to be attached to the rear of the tractor. This usually requires an additional worker to sit on the hoeing machine and steer it between the rows so that the plants are not damaged. This is time-consuming and expensive.

The driver of the Fobro-Mobil sits next to the diesel or petrol engine, offset to the side of the center. This has the advantage that the weight on the rear axle is evenly distributed over both wheels, ensuring good propulsion and even pressure on the ground. In the direction of travel of the Forbo-Mobil, for example, the weight of the driver is closer to the rear left wheel and the weight of the motor is closer to the rear right wheel. The front and rear wheels of the Fobro-Mobil are connected via two tubes or profiles, which has the disadvantage that when travelling on the road, the driver sees a connecting tube directly in front of them, which obstructs their view straight ahead. The second tube or profile to the right in the direction of travel obstructs the view to the right of the roadside, which can be dangerous for pedestrians and the distance to the roadside is difficult to judge.

Another vehicle that can fulfil this task is the Mastertrac (http://www.rath-maschinen.com/de/mastertrac.html). This vehicle is also powered by a diesel engine and has three implement holders. These are at the rear, front and in the center of the vehicle, directly in front of the driver. In this vehicle, the rear pair of wheels is also connected to the front pair of wheels, but with a curved profile next to the driver or, more precisely, between the side-mounted engine and the driver's seat. The driver's head is approximately at the same height as the aforementioned wheel connection. The driver's view of the chipper mounted in the center section is obstructed by the wheel connection mounted in the center and at head height. Visibility in road traffic is also obstructed by the positioning of this axle connection to the side of the road. Another disadvantage of this tractor is the lack of clearance from the lower edge of the axle connection to the ground. This means that large appliances cannot be lifted sufficiently, which is a disadvantage when transporting them on uneven terrain.

Such specialized tractors for tilling crop rows are supplied without cabs, as these would otherwise obstruct the clear view of the hoeing tools and add weight. With these specialized tractors for working low-growing rows of plants, it is important to eliminate any superfluous weight so as not to increase the ground pressure.

These special tractors with three attachments for soil cultivation implements are all powered by diesel or petrol engines. With ever stricter environmental protection regulations and the reduction of CO₂ emissions, it is becoming increasingly expensive to find suitable engines that have suitable exhaust gas aftertreatment systems to reduce CO₂ and fine particle emissions to the legal requirements.

Another problem is the health protection of the driver. The driver usually sits on the specialized tractor for several hours and works the soil. They sit directly next to the diesel or petrol engine while doing so. As these vehicles do not have a cab for functional reasons, the driver is unprotected and highly exposed to harmful exhaust emissions. The proximity to the engine means that the driver is also exposed to the loud engine noise without protection. They are therefore usually forced to wear ear protection.

DE 10 55 377 A describes a tractor for agricultural use having a chassis, which connects a front tractor part and a rear tractor part via a connecting element, has a driver's seat in the region of the rear tractor part, a drive and at least four wheels, wherein the connecting element extends horizontally to the front tractor part.

### SUMMARY OF THE INVENTION

The object of the invention is to create a tractor for agricultural use that avoids the above-mentioned disadvantages.

This object is solved by a tractor for agricultural use having the features of the invention.

In the special tractor according to the invention, the front tractor part and the rear tractor part are connected with a single connecting element, preferably consisting of a profile or tube or several profiles or tubes lying close together. This connecting element, which connects the front tractor part and the rear tractor part, is fitted so that the driver has a clear view under the connecting part to the right in the direction of travel. For this purpose, the distance from the height of the seat surface of the driver's seat, measured vertically upwards from the front edge of the seat surface, to the height of the lower edge of the connecting element must be at least 60 cm. The connecting part extends essentially horizontally to the front part of the tractor (which means that it can also slope slightly towards the front part of the tractor), where it merges into a vertical element on which the front wheels are suspended. The connecting part is therefore positioned above the driver's field of vision. The driver can therefore look under the connecting element to the right and also at an implement positioned behind the front part of the tractor. This enables precise maneuvering when cultivating plant rows.

The connecting element is located in the center of the longitudinal axle of the special tractor, so that the driver has a clear view to the front and also to the side of an implement mounted in the center of the tractor and has an unobstructed view when driving straight ahead and to the side of the road.

A further development of the invention consists of the connecting element of the chassis, which connects the rear and front parts of the tractor, being arranged at least 70 cm, preferably at least 80 cm, above the driver's seat.

Thus, the connecting element is preferably located in the center of the longitudinal axle of the special tractor, so that the driver has a clear view to the front and also to the side of an implement mounted in the center of the tractor and has an unobstructed view when driving straight ahead and to the side of the road.

This prevents the driver's forward field of vision from being restricted by the connecting element.

An advantageous embodiment of the invention consists of the wheels being individually suspended and individually driven.

Alternatively, it is also possible that pairs of rear wheels or pairs of front wheels are each connected via an axle and are jointly driven via the connecting axle.

Two wheels or all four wheels can be driven.

A preferred embodiment of the invention consists of at least one electric motor being provided as the drive.

In this context, it is preferable that the electric motor acts on the rear wheels.

However, it is also possible to provide an all-wheel drive.

### BRIEF DESCRIPTION OF THE DRAWINGS

A preferred exemplary embodiment is explained in more detail below with reference to drawings.

In the drawings:

FIG. 1 shows a perspective view of a tractor according to the invention,

FIG. 2 shows a side view of the tractor according to the invention,

FIG. 3 shows the section A-A from FIG. 2,

FIG. 4 shows a front view of the tractor according to the invention,

FIG. 5 shows the section B-B from FIG. 4,

FIG. 6 shows a top view of the tractor according to the invention.

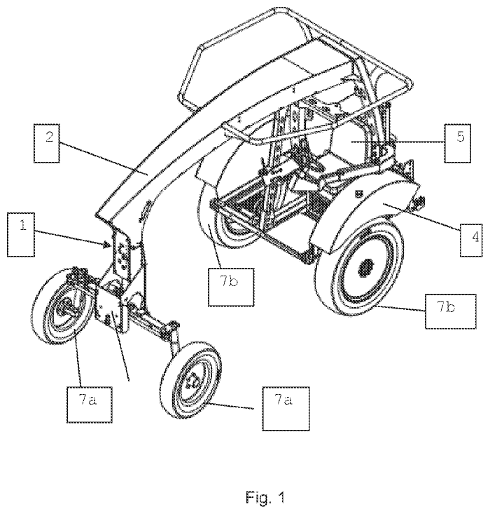

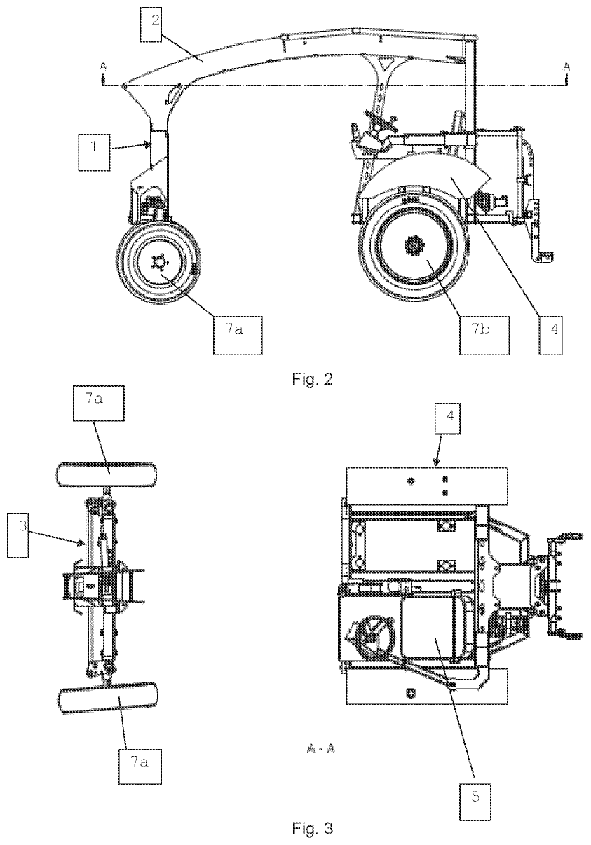

### DETAILED DESCRIPTION OF PREFERRED EMBODIMENTS

The tractor according to the invention for agricultural use has a chassis 1, which connects a front tractor part 3 and a rear tractor part 4 to one another via a connecting element 2. A driver's seat 5 and a drive 6 are provided in the rear tractor part 4. The tractor has at least four wheels 7a, 7b, preferably a pair of front wheels 7a and a pair of rear wheels 7b, which are aligned with each other. The wheels 7a, 7b can be suspended individually or connected in pairs via an axle.

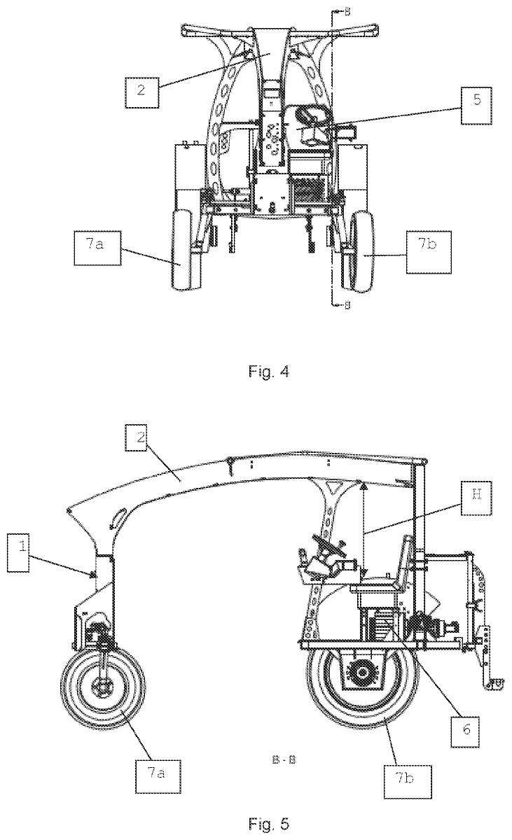

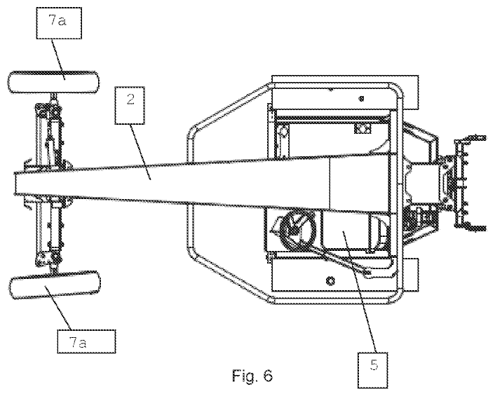

The connecting element 2 of the chassis 1, which connects the rear tractor part 4 and the front tractor part 3, is arranged at least 60 cm, preferably at least 70 cm and particularly preferably at least 80 cm above the driver's seat 5 (height H in FIG. 4) and extends essentially horizontally to the front tractor part 3. In this example, the essentially horizontal connecting element is slightly sloping towards the front. The underside of the connecting element 2 at the height of the front wheels 7a can be arranged up to 20% lower than at the highest point of the underside of the connecting element 2. The connecting element 2 is arranged in the center between the rear wheels 7b and preferably also arranged in the center between the front wheels 7a.

In the exemplary embodiment shown, the driver's seat 5 is arranged to the left of the connecting element 2 so as not to obstruct the driver's view to the front.

This type of arrangement of the connecting element 2 allows the driver to keep an eye on the implement located behind the front tractor section 3 when working in the field and to have a clear view when travelling on the road.

Either only the rear wheels 7b can be driven or all-wheel drive can be used.

Instead of a diesel or petrol engine, one or more electric motors are preferably used to power the drive, the hydraulics and the attached equipment. This prevents harmful exhaust emissions for the environment or the driver and avoids noise emissions for the driver. For this purpose, such a tractor with electric drive according to the invention can be used in greenhouses. Another advantage of using an electric motor is the utilization of solar, wind or biogas energy, which can be produced on site by the user. This can significantly reduce the operating costs of the electric tractor.

The electric motor(s) can drive the vehicle directly by acting directly on the axles or wheels 7a, 7b, or the electric motor can supply energy to a hydraulic circuit that drives the vehicle indirectly via the hydraulics. The attached implements can also be driven directly via the electric motor(s) or supplied with energy indirectly via hydraulic motors and hydraulic pumps. For this purpose, the tractor according to the invention has one or more hydraulic motors, one or more hydraulic pumps and one or more hydraulic oil circuits.

The electric motor(s) used have a total output of at least 25 KW, preferably at least 30 KW and most preferably at least 35 KW. For this purpose, each of the electric motors used has a voltage of at least 100 volts, preferably at least 360 volts. They are air-cooled or preferably water-cooled.

The electric tractor according to the invention has one or more batteries, together with a total power of preferably at least 25 KW, preferably at least 30 KW and most preferably at least 35 KW. One or more batteries can either be permanently installed or provided as replacement batteries, so that the user of the tractor according to the invention can extend the operating time by replacing pre-charged batteries. Commercially available batteries that are used to power electric cars are suitable. Lithium-ion batteries are particularly suitable.

The one or more batteries can be charged directly via a power cable from a power grid or another power source, such as a photovoltaic system, a wind energy system or a biogas system. The tractor according to the invention is electrically connected to a combined on-board charging system, which can preferably be connected bidirectionally to the electrical AC grid, which can reverse the energy flow as required, so that on the one hand the battery can be charged from the grid or, for example, from a photovoltaic system or wind energy system, and the stored energy can be released back into the grid or to other consumers as required. The battery can thus be used bidirectionally, i.e. it can absorb and store electricity on the one hand and release stored electricity on the other in order to supply external electrically operated devices with three-phase current. For this purpose, the electric tractor according to the invention has one or more standardized commercially available sockets that can be used for current consumption or as current outputs. This means that the electric tractor can be used as a mobile power supplier independent of a power grid.

If the electric tractor according to the invention is driven indirectly via hydraulic motors acting on one or more drive axles or several drive wheels, the hydraulic motor or motors may have one gear, or preferably two gears. With two-speed hydraulic motors, the speed of the first gear is preferably a maximum of 13 km/h with a tractive force between 7-12 kN. In second gear, the speed is preferably a maximum of 40 km/h with an output of between 4-7 kN.

The connecting element 2 between the rear tractor part 4 and the front tractor part 3 can be made of one or more angular profiles or tubes. The connecting element 2 is made of steel or dimensionally stable plastic, for example Kevlar. This connecting element 2 must not significantly impair the driver's view and has a maximum width of 50 cm in region a) (this is the region from the height of the wheel hub starting 2 m upwards along the connecting element 2), preferably a maximum of 40 cm, most preferably a maximum of 30 cm. The connecting element 2 can, for example, be designed as a hollow body, a U-profile, a double U-profile, a T-profile, a double T-profile or a triangular profile. This means that lines, cables or hydraulic hoses can be routed inside the connecting element 2 or attached to the connecting element 2 without any significant loss of visibility for the driver. The distance from the lower edge of the connecting element 2 to the ground surface is at least 150 cm, including the mounted wheels. This ensures that the attached implements, such as hoeing tools, can be lifted high enough from the ground in the center of the tractor.

The electric tractor according to the invention is equipped with a control system that optimally controls all hydraulic and electric drive components in such a way that the efficiency of the electric tractor according to the invention is maximized at every operating point. According to the invention, the electric motors and hydraulic components are controlled and regulated in such a way that all components work with maximum efficiency at every operating point of the tractor. The capacity of the batteries can therefore be better utilized. The battery can be selected smaller for the selected operating time, which leads to lower costs.

The electric tractor can also be equipped with an autopilot system. The autopilot system processes the information from the electric tractor's instruments, sensors, cameras and GPS and automatically keeps the electric tractor in the desired planting track.

The control of all hydraulic and electric drive components can be connected to the autopilot system. This provides the control system with additional information from the autopilot system, for example about the position, inclination, acceleration and speed, and improves the efficiency of the electric tractor using an internal algorithm.

1. A tractor for agricultural use having a chassis (1), which connects a front tractor part (3) and a rear tractor part (4) to one another via a connecting element (2), a driver's seat (5) in the region of the rear tractor part (4), a drive (6) and at least four wheels (7a, 7b), wherein the connecting element (2) of the chassis (1), which connects the rear tractor part (4) and the front tractor part (3) to one another, is arranged at least 60 cm above the driver's seat (5) and extends essentially horizontally to the front tractor part (3), wherein the front tractor part (3) and the rear tractor part (4) are connected with a single connecting element (2), which is arranged in the center between the rear wheels (7b) and in the center between the front wheels (7a) and the driver's seat (5) is arranged to the right or left of the connecting element (2), so that the driver has a clear view to the front and also to the side of an implement mounted in the center of the tractor and has an unobstructed view when driving straight ahead and to the side of the road.

2. The tractor according to claim 1, wherein the connecting element (2) of the chassis (1), which connects the rear tractor part (4) and the front tractor part (3) to one another, is arranged at least 70 cm, preferably at least 80 cm, above the driver's seat.

3.-5. (canceled)

6. The tractor according to claim 1, wherein the wheels (7a, 7b) are individually suspended and individually driven.

7. The tractor according to claim 1, wherein pairs of rear wheels (7b) or pairs of front wheels (7a) are each connected via an axle and are jointly driven via the connecting axle.

8. The tractor according to claim 1, wherein at least one electric motor is provided as the drive (6).

9. The tractor according to claim 8, wherein the electric motor acts on the rear wheels (7).

10. The tractor according to claim 1, wherein an all-wheel drive is provided.
